(19) United States
(12) Patent Application Publication
(10) Pub. No.: US 2007/0052248 A1
(43) Pub. Date: Mar. 8, 2007

(54) Electric or electro-mechanical machine locking device for a door

(75) Inventor: Stephan Gosch, Riepsdorf (DE)

Correspondence Address: COHEN, PONTANI, LIEBERMAN & PAVANE, 551 FIFTH AVENUE, SUITE 1210, NEW YORK, NY, 10176, US

(73) Assignee: Doma GmbH + Co KG, Ennepetal (DE)

(21) Appl. No.: 10/572,781

(22) PCT Filed: Sep. 6, 2004
(86) PCT No.: PCT/EP04/09895

§ 371 Date: Aug. 17, 2006

(30) Foreign Application Priority Data
Sep. 22, 2003 (DE) 103 44 146.8

(51) Int. Cl. E05C 1/06

(52) U.S. Cl. 292/144

(57) ABSTRACT

The invention relates to an electrical or electromechanical hold-open device, particularly for doors, which is displaceable within a sliding rail, the sliding rail comprising a lower chamber and an upper chamber, a power supply unit being disposed in the upper chamber and a slide member with a holding mechanism and a retaining mechanism being disposed in the lower chamber. This measure is intended to provide an electrical or electromechanical hold-open device which, compared to prior art hold-open devices, is improved particularly with regard to the power supply.

The invention relates to an electrical or an electromechanical hold-open device, which is disposed within a sliding rail and cooperates with a slide member, which is connected to a door closer or to a door drive via an arm.

Such hold-open devices serve to hold-open a swing door for example. They may be provided with a power supply to supply energy to the hold-open device, if the latter does not operate merely mechanically. Even though the operation of prior art hold-open devices is generally satisfactory, there is a need of improvement, particularly with regard to the power supply.

Therefore, it is an object of the present invention to provide an electrical or an electromechanical hold-open device having an improved and simplified construction compared to prior art hold-open devices.

This problem is solved with the features of claim 1.

According to the invention, the electrical or electromechanical hold-open device, particularly for doors, is displaceable within a sliding rail, the sliding rail comprising a lower chamber and an upper chamber, a power supply unit being disposed in the upper chamber, and a slide member with a holding mechanism and a retaining mechanism being disposed in the lower chamber.

As a result of this embodiment, the power supply and the hold-open device, which is displaceably supported within the sliding rail, are spatially separated from each other such that both a secure power supply and a functional guidance of the hold-open device within the sliding rail are guaranteed.

The dependent claims include advantageous further developments of the invention.

Further details, features and advantages of the invention will result from the following description of one preferred exemplary embodiment, reference being made to the drawings, in which

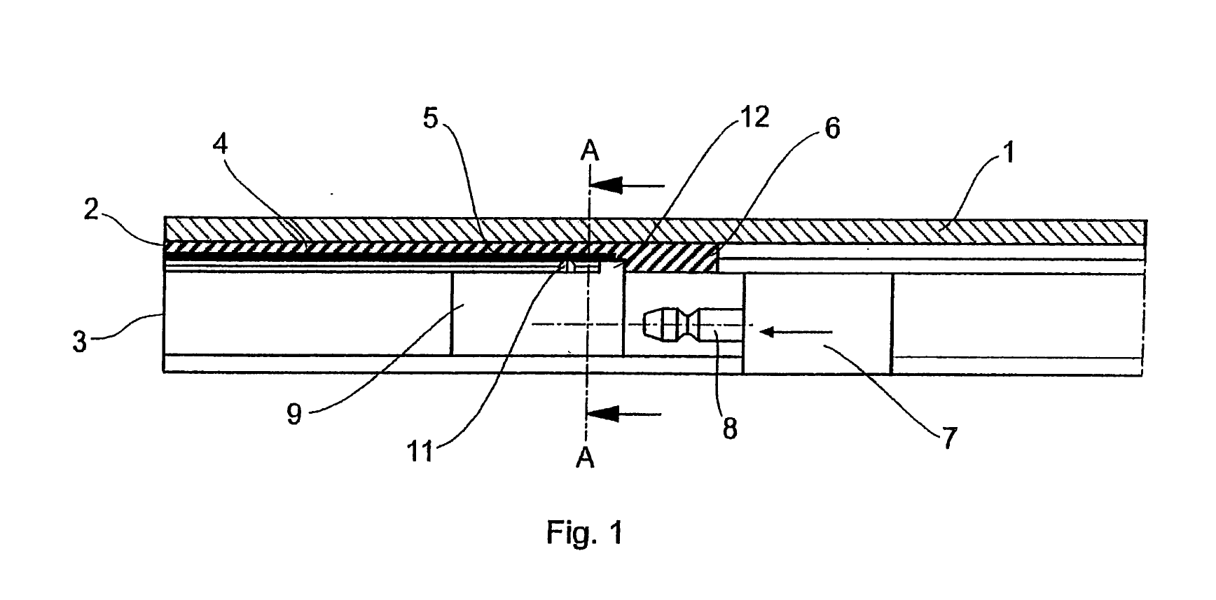

FIG. 1 shows a lateral view on the inventive hold-open device;

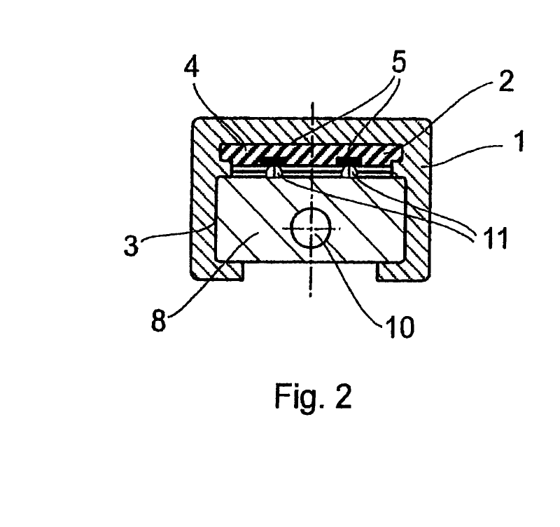

FIG. 2 shows a cross-section along line A-A in FIG. 1;

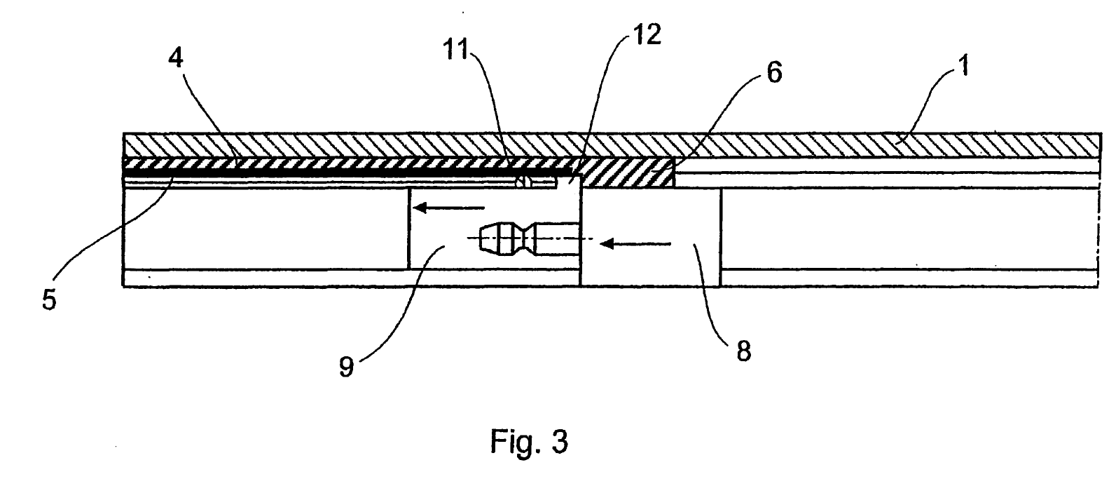

FIG. 3 shows a state during an opening movement of the inventive hold-open device, and

FIG. 3 shows a state during a closing movement of the inventive hold-open device.

The basic conception of the inventive hold-open device becomes obvious from FIGS. 1 and 2. An upper chamber 2 and a lower chamber 3 are formed within a sliding rail 1. The two chambers 2, 3 are separated from each other by means of a small bordering rib. A power supply unit 4, where, at the side thereof facing the lower chamber 3, two parallel conductor lines 5 are disposed, is disposed within the upper chamber 2. At one end, the power supply unit 4 is provided with a stopper 6, which extends in the direction of the lower chamber 3. The power supply unit 4 together with the stopper 6 is stationary disposed within the sliding rail 1 and extends, for example, over a partial length of the sliding rail 1 only.

A slide member 7 is disposed in the lower chamber 3. The slide member 7 is displaceably supported within the sliding rail 1 in the longitudinal direction. A holding mechanism 8, in the illustrated exemplary embodiment consisting of an undercut pin, is disposed at the slide member 7 and projects therefrom in the longitudinal direction of the sliding rail 1. A retaining mechanism 9, likewise displaceable in the longitudinal direction in the sliding rail 1, is supported within the lower chamber 3. This retaining mechanism 9 is provided with an opening 10 for the reception of the holding mechanism 8. Furthermore, the retaining mechanism 9, on the side thereof facing the upper chamber 2, has two spring-loaded contact pins 11, which are able to slide along the connector lines 5 in the upper chamber 2. The retaining mechanism 9 is provided with a projecting nose 12 cooperating with the stopper 6.

Hereinafter, the operation mode of the inventive hold-open device will be explained.

In the initial position, the retaining mechanism 9, with the projecting nose 12 thereof, abuts against the stopper 6. Now, the retaining mechanism 9 being energized, the slide member 7 together with the holding mechanism 8 approaches the retaining mechanism 9 (compare the position in FIG. 1). As the slide member 7 reaches the retaining mechanism 9, the holding mechanism 8 penetrates into the retaining mechanism 9 and pushes the latter into the opening direction, i.e. to the left side in FIG. 1.

To achieve that the retaining mechanism 9 is not displaced during penetration of the holding mechanism 8, prior to reaching a secure locking between the holding mechanism 8 and the retaining mechanism 9, there is a contact force between the stopper 6 and the retaining mechanism 9 which is greater than the latching force, which is exerted by the holding mechanism 8 when it penetrates into the retaining mechanism 9. This holding force can be generated by magnets, for example. The contact force will be released only when the slide member together with the retaining mechanism 9 travels further to the left side in FIG. 3 and thus pushes the retaining mechanism 9 away from the stopper 6. In this case, the slide member 7, on account of the form thereof, passes underneath the stopper 6 and pushes the retaining mechanism 9 to the left side in FIG. 3.

Depending on the length of the conductor lines 5 in the power supply unit 4, the retaining mechanism is more or less energized during a displacement into the opening direction.

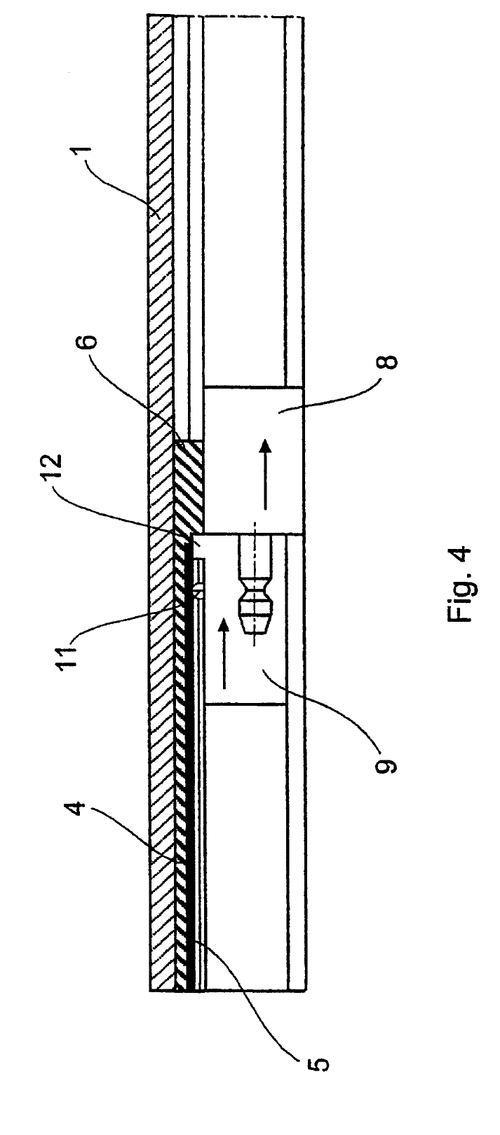

Once the retaining mechanism 9 has left the area of the power supply unit 4, the holding mechanism 8 is no longer retained in the retaining mechanism 9. If, the retaining mechanism 9 being in this de-energized state, the slide member 7 moves into the closing direction i.e. to the right side in FIG. 3, the retaining mechanism 9 as well must be entrained back. A contact force, generated by magnets for example, is provided for this purpose between the slide member 7 and the retaining mechanism 9 which guarantees a secure entrainment of the retaining mechanism 9. Thus, upon automatic closure of the door, the slide member 7 and the retaining mechanism 9 move together into the closing direction, i.e. to the right side in FIG. 4. As soon as the contact pins 11 contact again the current carrying conductor lines 5, the retaining mechanism 9 is energized and the holding mechanism 8 is locked in the retaining mechanism 9.

As soon as the projecting nose 12 of the retaining mechanism 9 abuts against the stopper 6 (compare FIG. 4), the door is prevented from further closing, as the slide member 7 as well is retained through the interlocking action of the holding mechanism 8 and the retaining mechanism 9. It is only after the required release force is exerted on the door that the interlocking action is overcome and the door can be closed by a door closer, for example.

With the retaining mechanism 9 being de-energized, the above described functioning will be same, with the exception that the retaining mechanism 9 will remain at the stopper 6 and the slide member 7 together with the holding mechanism 8 will pass underneath the stopper 6, as the interlocking action between the holding mechanism 8 and the retaining mechanism 9 is not activated.

### REFERENCES

1 sliding rail
2 upper chamber
3 lower chamber
4 power supply unit
5 conductor line
6 stopper
7 slide member
8 holding mechanism
9 retaining mechanism
10 opening
11 contact pin
12 projecting nose

1-10. (canceled)

11. An electrical or electromechanical hold-open device for door, comprising:
a sliding rail defining at least one upper chamber and at least one lower chamber;
a power supply unit disposed in the at least one upper chamber;
a displaceable slide member disposed in the at least one lower chamber;
a holding mechanism coupled to the displaceable slide member; and
a retaining mechanism disposed in the lower chamber, said retaining mechanism being in operative connection with the power supply unit and being arranged and dimensioned to receive the holding mechanism.

12. The electrical or electromechanical hold-open device according to claim 11, wherein the power supply unit includes two parallel conductor lines.

13. The electrical or electromechanical hold-open device according to claim 12, wherein the retaining mechanism includes two spring-loaded contact pins which cooperate with the two conductor lines of the power supply unit.

14. The electrical or electromechanical hold-open device according to claim 11, wherein the displaceable slide member together with the holding mechanism and the retaining mechanism is displaceable in a longitudinal direction of the sliding rail.

15. The electrical or electromechanical hold-open device according to claim 11, wherein the power supply unit only extends over a partial length of the sliding rail.

16. The electrical or electromechanical hold-open device according to claim 11, wherein a stopper is provided at one end of the power supply unit for cooperating with the retaining mechanism.

17. The electrical or electromechanical hold-open device according to claim 1, wherein the holding mechanism protrudes from the displaceable slide member and penetrates into the retaining mechanism for holding the door open, and is retained therein when the retaining mechanism is energized.

18. The electrical or electromechanical hold-open device according to 11, wherein the holding mechanism comprises an undercut pin.

19. The electrical or electromechanical hold-open device according to claim 16, wherein a contact force is generated between the stopper and the retaining mechanism, said contact force being greater than a latching force with which the holding mechanism penetrates the retaining mechanism.

20. The electrical or electromechanical hold-open device according to claim 11, wherein a contact force between the retaining mechanism and the slide member is generated by magnets.

21. The electrical or electromechanical hold-open device according to claim 19, wherein the contact force is generated by magnets.

22. The electrical or electromechanical hold-open device according to 14, wherein the holding mechanism comprises an undercut pin.

23. The electrical or electromechanical hold-open device according to 17, wherein the holding mechanism comprises an undercut pin.
